(19) United States
(12) Patent Application Publication
(10) Pub. No.: US 2015/0136429 A1
(43) Pub. Date: May 21, 2015

(54) Cooking Apparatus and Method to Reduce or Prevent Ignition of Contents

(71) Applicant: STATE FARM MUTUAL AUTHOMOBILE INSURANCE COMPANY, Bloomington, IL (US)

(72) Inventor: Patrick Harold Boyer, Bloomington, IL (US)

(73) Assignee: STATE FARM MUTUAL AUTHOMOBILE INSURANCE COMPANY, Bloomington, IL (US)

(21) Appl. No.: 14/086,122

(22) Filed: Nov. 21, 2013

(51) Int. Cl. A47J 37/10; A62C 3/00

(52) U.S. Cl. CPC A47J 37/108; A62C 3/006
USPC 169/45; 220/370; 126/299 C

(57) ABSTRACT

A cooking apparatus comprises a base having a top surface and a circumference. An annular side wall is attached to the base and surrounds the circumference of the base. A flame arrestor member is disposed on the top surface of the base, wherein the flame arrestor member prevents ignition of one of material or liquid disposed on the top surface of the base.

### FIELD OF TECHNOLOGY

The present disclosure relates generally to cookware, and, more specifically, to a stove top cooking apparatus and method for reducing or preventing ignition in the same.

### BACKGROUND OF THE DISCLOSURE

Cooking equipment-related fires are the leading cause of US fire loss, according to the National Fire Protection Association (NFPA). For example, during the five-year period of 2006-2010, cooking equipment was involved in an average of 157,300 reported home structure fires, with associated losses of 380 civilian deaths, 4,920 civilian injuries, and $794 million in direct property damage per year.

The Fire Protection Research Foundation (Foundation), an affiliate of NFPA, with a grant from the National Institute of Standards and Technology (NIST), is addressing this concern. For example, the Foundation supports a research project titled “Development of Standard Cooking Fire Scenarios and Candidate Test Methods for Evaluating Cooking Fire Mitigation Technologies,” to examine three main areas of cooking fires and develop an action plan towards improving overall cooking fire safety. The project focuses on the development of the means for implementing prevention technologies that are suitable for use on or with home cooking appliances. The three categories of cooking-related fires to be studied are: (1) fires starting in a pot or pan on a burner; (2) fires due to food spillage on a burner; and (3) products, such as utensils, oven mitts and other items that catch fire on or near a burner.

For the last three decades, NIST, the Consumer Product Safety Commission, and the home appliance industry have undertaken a series of comprehensive strategy reviews to reduce the number of deaths, injuries and property losses from cooking fires. In February, 2010, a Vision 20/20 workshop was held on this topic, which resulted in a Foundation study, Home Cooking Fire Mitigation: Technology Assessment. The study, also supported by NIST, was aimed at developing an action plan to assess the performance of home-cooking safety technologies.

Historically, leading researchers in this field and industry experts have addressed the topic of cooking fires by focusing on several factors. Such factors include: (1) physically modifying the stove to control burner temperatures; (2) educating users of cooking food to modify behaviors; (3) alerting occupants of the residence of a fire through an alarm system, i.e., smoke alarm or fire alarm; and (4) employing fire suppression systems using a handheld fire extinguisher, a locally fixed, pre-engineered fire extinguishing system or residential sprinklers. However, while each of these factors has its place in the accident causation chain of events, they do not address a key element: the role that cookware plays in the fire scenario.

### SUMMARY OF THE DISCLOSURE

In accordance with a first exemplary aspect of the present disclosure, a cooking apparatus comprises a base having a top surface and a circumference, and an annular side wall attached to the base and surrounding the circumference. The cooking apparatus further includes a flame arrestor member disposed on the top surface of the base, wherein the flame arrestor member prevents the ignition of one of material or liquid disposed on the top surface of the base.

In accordance with a second exemplary aspect, a cooking apparatus comprises a base having a top surface and a bottom surface adapted to contact a portion of a stove top and a circumference. The cooking apparatus further includes an annular side wall extending along the circumference of the base and having an inside surface and a center. At least one protrusion inwardly extends from the inside surface of the annular side wall one of below, at or above the center of the side wall and above the bottom surface of the base, wherein the at least one protrusion displaces an amount of oxygen near the top surface of the base, prolonging an average time required to ignite one or more of material or liquid disposed on the top surface of the base.

In accordance with a third exemplary aspect, a system for preventing or reducing ignition of material or liquid disposed in cookware comprises a cooking apparatus having a base with a top surface, a circumference, and an annular side wall attached to the base and surrounding the circumference, the annular side wall having a rim. A curvature device is removably secured to the rim of the side wall and comprises an inwardly sloping ring, and at least one attachment member having a first end mounted to the ring, and a second end removably secured to the rim of the annular side wall of the cooking apparatus. The inwardly sloping ring increases an inner curvature of the side wall of the cooking apparatus to displace oxygen, increasing an average ignition time of one of material or liquid disposed on the base.

In accordance with a fourth exemplary aspect, a method of reducing or preventing ignition of material or liquid disposed in a cooking apparatus having a base with a top surface and a circumference, and an annular side wall extending along the circumference of the base and having an inside surface and a rim is disclosed. The method comprises displacing oxygen disposed near the top surface of the base of the cooking apparatus via one of at least one protrusion secured to the inside surface of the annular side wall above the top surface of the base or an inwardly sloping ring removably secured to the rim of the annular side wall. The method further comprises increasing an average ignition time of one or more of material or liquid disposed on the top surface of the base.

### BRIEF DESCRIPTION OF THE DRAWINGS

FIG. 1 is a cross-sectional view of an example cooking apparatus of the present disclosure taken along the line A-A of FIG. 2;

FIG. 2 is a top view of the cooking apparatus of FIG. 1;

FIG. 3 is a cross-sectional view of another example cooking apparatus of the present disclosure taken along the line B-B of FIG. 4;

FIG. 4 is a top view of the example cooking apparatus of FIG. 3;

FIG. 5 is a cross-sectional view of another example cooking apparatus of the present disclosure taken along the line C-C of FIG. 6;

FIG. 6 is a top view of the example cooking apparatus of FIG. 5;

FIG. 7 is a perspective view of another example cooking apparatus of the present disclosure; and

FIG. 8 is a top view of the example cooking apparatus of FIG. 7.

### DETAILED DESCRIPTION OF THE DISCLOSURE

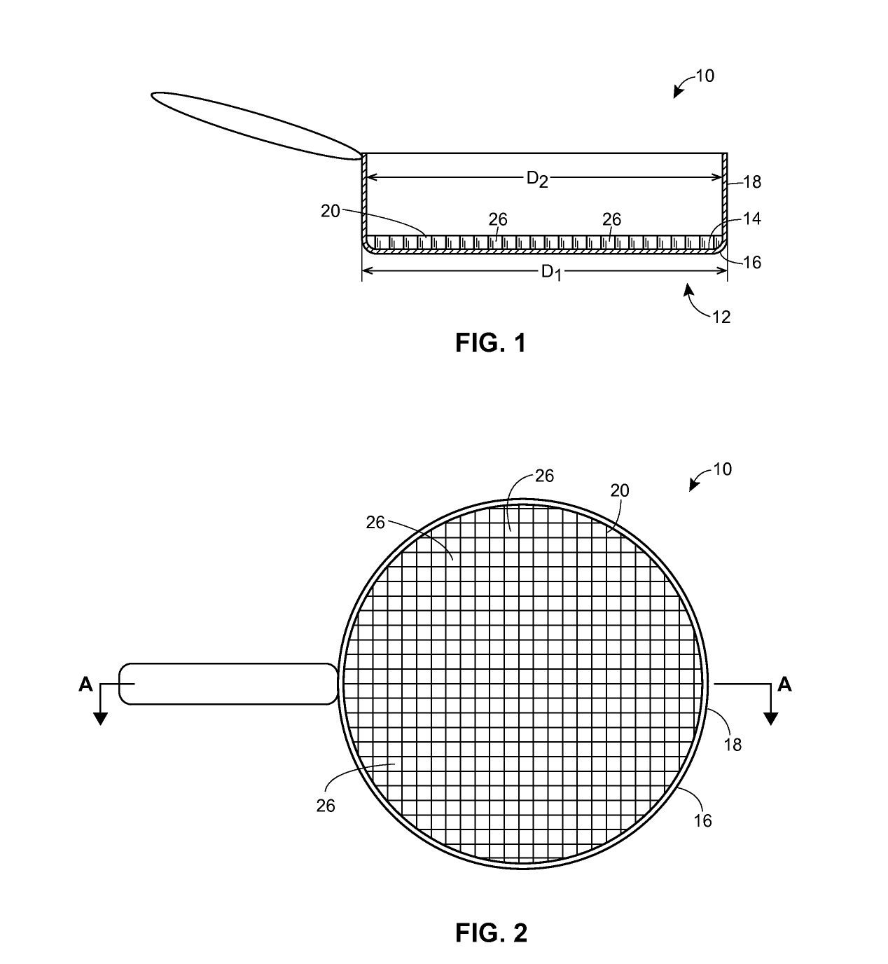

Referring now to FIGS. 1 and 2, an example cooking apparatus 10 of the present disclosure is depicted. As illustrated therein, the cooking apparatus 10 includes a base 12 having a top surface 14 and a circumference 16. The cooking apparatus 10 further includes an annular side wall 18 that is attached to the base 12 along the circumference 16. A flame arrestor member 20 is disposed on the top surface 14 of the base 12 and prevents ignition of one of material or liquid disposed on the top surface 14 of the base 12. The material or liquid includes various cooking oils, for example, disposed in the cooking apparatus 10. The cooking apparatus 10 may include a stove top skillet or other similar stove top pan. In addition, while one example size of the stove top cooking apparatus 10 is depicted in FIGS. 1 and 2, the cooking apparatus 10 may also have various other sizes and shapes and still fall within the scope of the present disclosure.

The flame arrestor member 20 uses principles of flame arrestors to prevent the ignition of cooking oils, for example, disposed on the top surface 14 of the base 12. In other words, the flame arrestor member 20 stops fuel combustion by extinguishing a flame. More specifically, the flame arrestor member 20 includes channels 26 through which a flame is forced. The channels 26 are designed to be too narrow to permit continuance of any flame. These passages or channels 26 may together comprise a wire mesh or a sheet metal plate with punched holes or dimples, as explained in more detail below. The required size of the channels 26 needed to stop the flame can vary, depending on the flammability of the liquid, material or some other mixture disposed on the top surface 14 of the base 12. In one example, the channels 26 have a width in the range of about ⅛^{th} of an inch to about ¼^{th} of an inch and a length in the same range of about ⅛^{th} of an inch to about ¼^{th} of an inch. In another example, the channels 26 have a width in the range of about 1/12^{th} of an inch to about ¼^{th} of an inch and a length in the same range of about 1/12^{th} of an inch to about ¼^{th} of an inch. In yet another example, the channels 26 may have a width in the range of about 1/12^{th} of an inch to about ½ of an inch and a length in the same range of about 1/12^{th} of an inch to about ½ of an inch. In yet another example, the channels have a width in the range of about 2 to 3 mm (0.078 inches to 0.118 inches) and a length in the same range.

In some examples, the flame arrestor member 20 may comprise a screen or shield having the mesh structure with a plurality of channels 26, as illustrated in FIGS. 1 and 2, for example. In other examples, the flame arrestor member 20 may comprise a metal plate having one or more of dimples (not shown), holes and screens, for example. Such dimples may create passages similar to channels 26 in both form and function, e.g., preventing continuance of a flame through such dimples.

As further illustrated in FIG. 1, the base 12 has a diameter D1 and the flame arrestor member 20 has a diameter D2 that is less than the base diameter D1. While FIG. 1 depicts the diameter D2 of the flame arrestor member 20 as being only slightly less than the base diameter D1, the flame arrestor diameter D2 may be substantially less than the base diameter D1 and still prevent ignition of material or liquid disposed on the top surface 14 of the base 12 of the cooking apparatus 10 during use. More specifically, in order to still prevent ignition of material or liquid disposed on the top surface 14 of the base 12, the diameter D2 of the flame arrestor member 20 must be at least about 50% of the diameter D1 of the base 12. One of ordinary skill in the art will appreciate that the diameter D2 of the flame arrestor member 20 may be slightly less than 50% of the diameter D1 of the base 12 and still fall within the scope of the present disclosure.

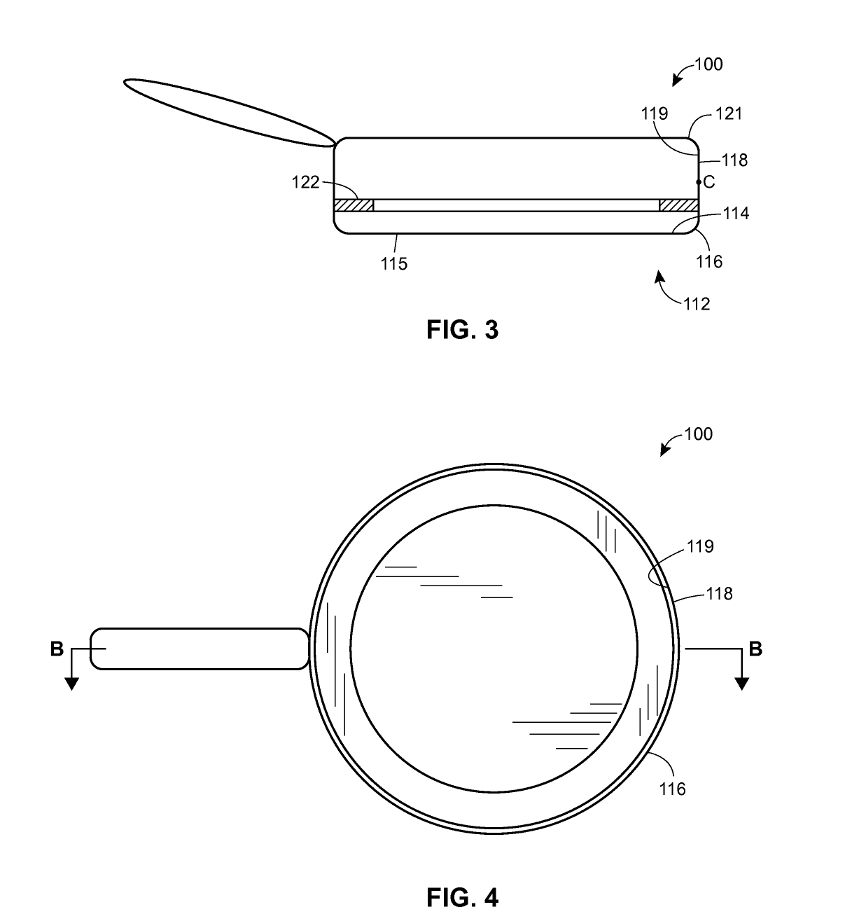

Referring now to FIGS. 3 and 4, another example cooking apparatus 100 is depicted. In a manner similar to the cooking apparatus 10 of FIGS. 1 and 2, the cooking apparatus 100 includes a base 112 having a top surface 114, a bottom surface 115 adapted to contact a portion of a stove (not shown), and a circumference 116. The cooking apparatus 100 further includes an annular side wall 118 extending along the circumference 118 of the base 112. The annular side wall 118 includes an inside surface 119, a rim 121, and a center point C disposed mid-way between the rim 121 and the top surface 114 of the base 112.

An annular protrusion 122 inwardly extends from the inside surface 119 of the annular side wall 118 below the center point C and above the bottom surface 114 of the base 112 of the cooking apparatus 100. In other examples, while not illustrated, the annular protrusion 122 may inwardly extend from the inside surface 119 of the annual side wall 118 at or above the center point C and also above the bottom surface 114 of the base 112 of the cooking apparatus 100 and still fall within the scope of the present disclosure. Using principles of oxygen depletion, in each example, the annular protrusion 122 depletes or displaces an amount or level of oxygen near the top surface 114 of the base 112 or floor of the cooking apparatus 100. More specifically, the protrusion 112 reduces oxygen by recirculating moisture, gases, and oils, for example, back into the top surface 114 of the base 112, which reduces an overall temperature of material or liquid, such as cooking oil, and displaces the oxygen. Such oxygen displacement by the annular protrusion 122 prolongs an average time required to ignite one or more of material or liquid, such as various cooking oils, disposed on the top surface 114 during use of the cooking apparatus 100.

In one example, the average time required to ignite cooking oils, for example, disposed on the top surface 114 of the cooking apparatus is approximately five minutes. The annular protrusion 122 is able to increase or prolong the average time of ignition. In one instance, the annular protrusion 122 may increase or prolong the average time of ignition approximately two minutes, increasing the average time of ignition to approximately seven minutes. As one of ordinary skill in the art will appreciate, such average times may vary depending upon the cooking oil or other material disposed on the top surface 114 of the base 112 and further in view of the level of heat applied to the bottom surface 115 of the base 112 during use. In any case, however, the annular protrusion 122 increases or prolongs the average time of ignition, reducing the possibility or incidence of unwanted ignition of cooking oils, for example.

The annular protrusion 122 extends perpendicular to the annular side wall 118 of the cooking apparatus 100 and may be approximately one half of an inch in width, for example. One of ordinary skill in the art will appreciate that the annular protrusion 122 may alternatively be in the range of approximately ¼^{th} of an inch to ¾^{th} of an inch or even one inch in width and still fall within the scope of the present disclosure. More generally, any size or shape of the annular protrusion 118 that still functions to increase or prolong the average time of ignition of material disposed within the cooking apparatus 100 would still fall within the scope of the present disclosure. In other examples, the annular protrusion 122 may upwardly or downwardly extend from the annular side wall 118 at an angle that is not perpendicular to the annular side wall 118 and may also be curved in one or more of a convex or a concave manner. Specifically, the annular protrusion 122 may have a concave surface, such as a concave outside surface that extends along the circumference 116 of the base 112.

The annular protrusion 122 may be an add-on device or an integral part of the cooking apparatus 100. If an add-on device, the annular protrusion 122 may be press fit or snapped into or otherwise secured to the inside surface 119 of the annular side wall 118 via various fasteners (not shown) including, but not limited to, an adhesive or other bonding material, a clip, a pin, or other similar fastener capable of allowing the annular protrusion to be removably secured to the cooking apparatus 100. In addition, the annular protrusion 122 may be welded to the inside surface 119 of the annular side wall 118 or otherwise secured or attached to the inside surface 119 via any method of spinning, e.g., metal spinning, commonly known to persons having ordinary skill in the art. Whether an integral part or add-on device, the annular protrusion 122 is made of the same or substantially the same material as the cooking apparatus 100.

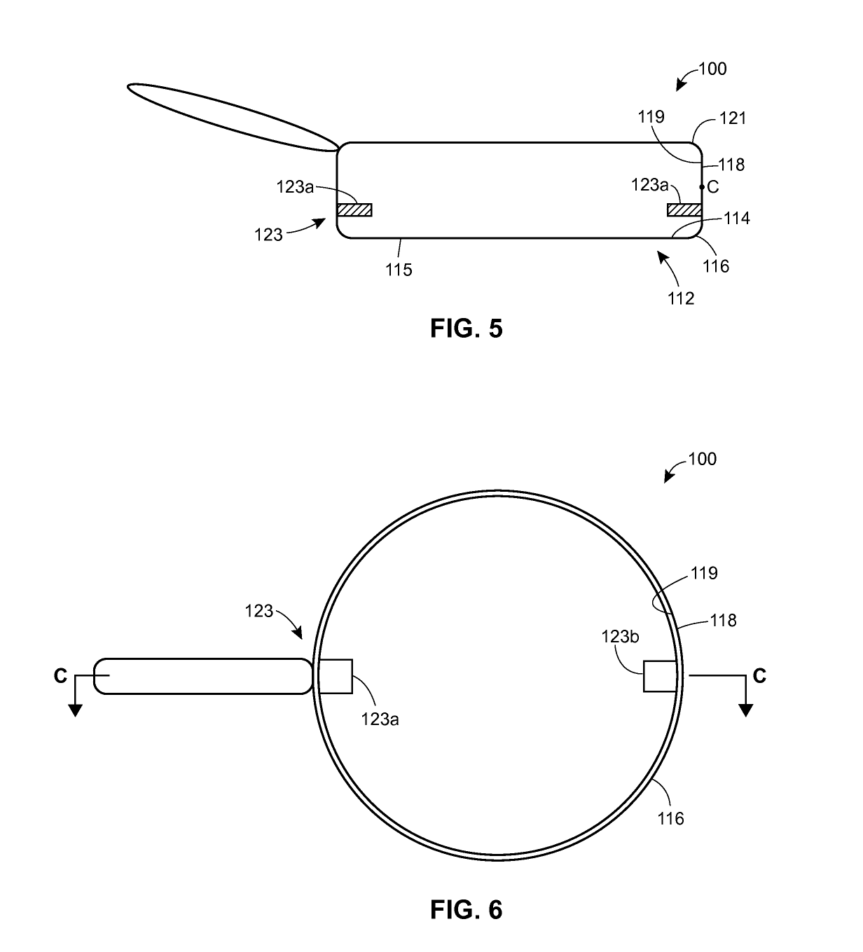

Referring now to FIGS. 5 and 6, another example of the protrusion 122 of FIGS. 3 and 4 is depicted. More specifically, instead of the annular protrusion 122, the cooking apparatus 100 may alternatively include at least one non-continuous segment or protrusion 123 that includes a rod or bar inwardly extending in the range of approximately ¼^{th} of an inch to ¾^{th} of an inch from the inside surface 119 of the annular wall 118. In addition or in lieu of the rod or bar of the at least one non-continuous segment or protrusion 123, a person having ordinary skill in the art will appreciate that the shape of each non-continuous segment or protrusion 123 may alternatively be curved in an upward or downward direction from the inside surface 119 of the annular side wall 118 or any other shape, such as a semi-circle, rectangle or square, and still fall within the scope of the present disclosure. Further, the at least one non-continuous segment or protrusion 123 may inwardly extend in the range of approximately ⅛^{th} of an inch or 1 inch from the inside surface of the annular wall 118, along with various other similar sizes, and still fall within the scope of the present disclosure.

In one example, the at least one non-continuous segment or protrusion 123 comprises a pair of non-continuous segments or protrusions 123, each of which may also include a rod or a bar inwardly extending in the range of approximately ¼^{th} of an inch to ¾^{th} of an inch from the inside surface 119 of the annular wall 118. More specifically, the pair of non-continuous segments or protrusions 123 may include a first non-continuous segment or protrusion 123a inwardly extending from the inside surface 119 of the annular wall 118 and a second non-continuous segment or protrusion 123b also inwardly extending from the inside surface 119 of the annular wall 118 opposite the first non-continuous segment or protrusion 123a. In one example, both the first and second non-continuous segments or protrusions 123a and 123b extend about one half (½) of an inch from the inside surface 119 of the annular wall 118. In another example, the at least one non-continuous segment or protrusion 123 includes three non-continuous segments or protrusions 123 (not shown) that are equally spaced along the circumference 116 of the cooking apparatus 100, and, in yet another example, the at least one non-continuous segment or protrusion 123 includes four non-continuous segments or protrusions 123 (not shown) that are likewise equally spaced along the circumference 116 of the cooking apparatus 100. One of ordinary skill in the art will appreciate that any number of non-continuous segments or protrusions 123 greater than four, for example, may alternatively inwardly extend from the inside surface 119 of the annular wall 118 and still fall within the scope of the present disclosure.

Like the annular protrusion 122 depicted in FIGS. 3 and 4, the pair of protrusions 123 of FIGS. 5 and 6 also depletes or displaces oxygen near the top surface 114 of the base 112 or floor of the cooking apparatus 100 by recirculating moisture, gases, including any gases and particulates produced during the cooking process, and oils, for example, back into the top surface 114 of the base 112. Such recirculation reduces an overall temperature of material or liquid, such as cooking oil, and displaces the oxygen. As a result, an average time required to ignite one or more of material or liquid, such as various cooking oils, disposed on the top surface 114 during use of the cooking apparatus 100 is increased.

Further like the annular protrusion 122, the at least one non-continuous segment or protrusion 123 extends perpendicular to the annular side wall 118 of the cooking apparatus 100 and may have a concave surface, such as a concave outside surface that extends along the circumference 116 of the base 112. In addition, the at least one non-continuous segment or protrusion 123 may be an add-on device or an integral part of the cooking apparatus 100. If an add-on device, the at least one non-continuous segment or protrusion 123 may be press fit or snapped into or otherwise secured to the inside surface 119 of the annular side wall 118 via various fasteners (not shown) including, but not limited to, an adhesive or other bonding material, a clip, a pin, or other similar fastener capable of allowing the annular protrusion to be removably secured to the cooking apparatus 100. In addition, the at least one non-continuous segment or protrusion 123 may be welded to the inside surface 119 of the annular side wall 118 or otherwise secured to the inside surface 119 via any method of spinning, e.g., metal spinning, commonly known to persons having ordinary skill in the art. Whether an integral part or add-on device, the non-continuous segments or protrusions 123 are made of the same or substantially the same material as the cooking apparatus 100.

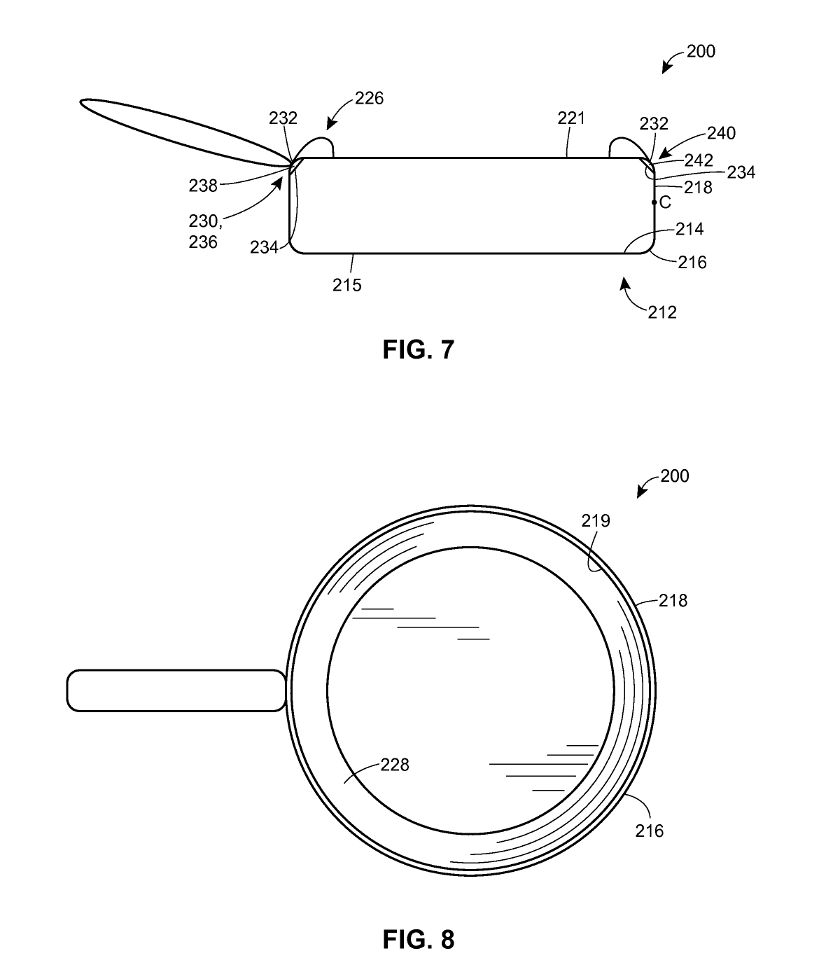

Referring now to FIGS. 7 and 8, another example cooking apparatus 200 is depicted. In a manner similar to the cooking apparatus 10 of FIGS. 1 and 2, the cooking apparatus 200 includes a base 212 having a top surface 214, a bottom surface 215 adapted to contact a portion of a stove (not shown), and a circumference 216. The cooking apparatus 200 further includes an annular side wall 218 extending along the circumference 218 of the base 212. The annular side wall 218 includes an inside surface 219, a rim 221, and a center point C disposed mid-way between the rim 221 and the top surface 214 of the base 212.

The cooking apparatus 200 further includes a curvature device 226 removably secured to the rim 221 of the annular side wall 218. The curvature device 226 may include an inwardly sloping ring 228 (FIG. 8) and at least one attachment member 230 having a first end 232 mounted to a portion of the inwardly sloping ring 228 and a second end 234 removably secured to the rim 221 of the annular side wall 218 of the cooking apparatus 200, as explained in more detail below. The inwardly sloping ring 228 effectively increases an inner curvature of the annular side wall 218 of the cooking apparatus 200 to displace oxygen, increasing an average ignition time of one of material or liquid, such as cooking oil, disposed on the top surface 214 of the base 212 or floor of the cooking apparatus 200.

In one example, the at least one attachment member 230 comprises a first clip 236 having at least one leg 238 for receiving the rim 221 of the annular side wall 218 and a second clip 240 disposed at a location along the rim 221 of the annular side wall 218 opposite the first clip 236. The second clip 240 also includes at least one leg 242 for receiving another portion of the rim 221 of the annular side wall 218, allowing the curvature device 226 to be removably secured to the cooking apparatus 200. The inwardly sloping ring 228 of the curvature device 226 may extend from the annular side wall 218 approximately ⅛^{th} to ¼^{th} of an inch and may include a concave top surface. As one of ordinary skill in the art will appreciate, the inwardly sloping ring 228 may also extend from the annular side wall 218 anywhere in the range of approximately 1/12^{th} of an inch to one inch and still fall within the scope of the present disclosure. In addition, the top surface of the inwardly sloping ring 228 may be one or more of concave or angled and also still fall within the scope of the present disclosure.

In one example, each of the cooking apparatuses 10, 100 and 200 of the present disclosure is made of aluminum due to its good machining ability, for example. While each of the cooking apparatuses 10, 100 and 200 comprise aluminum, one of ordinary skill in the art will appreciate that other materials may also be used in addition to or in lieu of aluminum, such as one or more of metal alloys, copper, copper clad metals, stoneware, and enamels, that have the same or at least similar properties of aluminum, such as good machining ability, and still fall within the scope of the present disclosure.

In addition, each of the cooking apparatuses 10, 100, and 200 of the present disclosure is a stove stop pan or skillet The skillets or pans may be one of various shapes and sizes and still fall within the scope of the present disclosure.

While the present invention has been described with reference to specific examples, which are intended to be illustrative only and not to be limiting of the invention, it will be apparent to those of ordinary skill in the art that changes, additions or deletions may be made to the disclosed embodiments without departing from the spirit and scope of the invention. More generally, although certain example apparatus has been described herein, the scope of coverage of this patent is not limited thereto. On the contrary, this patent covers all methods, apparatus and articles of manufacture fairly falling within the scope of the appended claims either literally or under the doctrine of equivalents.

1. A cooking apparatus comprising:
a base having a top surface and a circumference;
an annular side wall attached to the base and surrounding the circumference of the base;
a flame arrestor member disposed on the top surface of the base,
wherein the flame arrestor member prevents the ignition of one of material or liquid disposed on the top surface of the base.

2. The cooking apparatus of claim 1, wherein the cooking apparatus is one of a stove top skillet or a pan, and a material of the cooking apparatus is aluminum.

3. The cooking apparatus of claim 1, wherein the flame arrestor member includes one of a screen or shield having a mesh structure with a plurality of channels.

4. The cooking apparatus of claim 3, wherein each channel of the plurality of channels has a width and a length in the range of about 1/12th of an inch to ¼th of an inch.

5. The cooking apparatus of claim 1, the base further comprising a diameter, and the flame arrestor member further comprising a diameter that is at least approximately 50% of the diameter of the base to prevent ignition.

6. A cooking apparatus comprising:
a base having a circumference, a top surface, and a bottom surface for contacting a portion of a stove top;
an annular side wall extending along the circumference of the base and having an inside surface and a center; and
an annular protrusion inwardly extending from the inside surface of the annular side wall at or above the center of the side wall and above the bottom surface of the base, wherein the annular protrusion displaces an amount of oxygen near the top surface of the base, prolonging an average time required to ignite one or more of material or liquid disposed on the top surface of the base.

7. The cooking apparatus of claim 6, wherein the cooking apparatus is one of a stove top skillet or a pan, and a material of the cooking apparatus is aluminum.

8. The cooking apparatus of claim 6, wherein the annular protrusion has a width in the range of approximately ⅛th of an inch to 1 inch.

9. The cooking apparatus of claim 6, wherein the annular protrusion extends perpendicular to the side wall of the cooking apparatus, and above the bottom surface of the base.

10. The cooking apparatus of claim 6, wherein the annular protrusion includes a concave surface, such as an outside concave surface.

11. The cooking apparatus of claim 6, wherein the annular protrusion is an add-on device adapted to be secured to a cooking apparatus, and the material of the protrusion is the same material as the material of the cooking apparatus.

12. The cooking apparatus of claim 6, wherein the average time is approximately five minutes, and the average time for ignition is increased to a time greater than five minutes.

13. A system for preventing or reducing ignition of material or liquid disposed in cookware, the system comprising:
a cooking apparatus having a base with a top surface, a circumference, and an annular side wall attached to the base and surrounding the circumference, the annular side wall having a rim; and
curvature device removably secured to the rim of the side wall and comprising:
an inwardly sloping ring, and
at least one attachment member having a first end mounted to the ring, and a second end removably secured to the rim of the annular side wall of the cooking apparatus,
wherein the inwardly sloping ring increases an inner curvature of the side wall of the cooking apparatus to displace oxygen, increasing an average ignition time of one of material or liquid disposed on the base.

14. The system of claim 13, wherein the at least one attachment member comprises a first clip having at least one leg for receiving the rim of the annular side wall of the cooking apparatus, and a second clip disposed at a location along the rim of the annular side wall opposite the first clip, the second clip further including at least one leg for receiving another portion of the rim of the annular side wall of the cooking apparatus, allowing the curvature device to be removably secured to the cooking apparatus.

15. The system of claim 13, wherein both the cooking apparatus and the curvature device are made at least in part of aluminum.

16. The system of claim 13, wherein the cooking apparatus is one of a stove top skillet or a pan.

17. The system of claim 13, wherein the average ignition time is approximately five minutes, and the curvature device displaces oxygen flowing into the base of the cooking apparatus, thereby increasing the average ignition time to a time greater than five minutes.

18. The system of claim 13, wherein the inwardly sloping ring may extend approximately ⅛th to ¼th of an inch from the annular side wall.

19. The system of claim 13, wherein the inwardly sloping ring includes a top surface having one or more of a concave surface or an angled surface.

20. A method of reducing or preventing ignition in a cooking apparatus having a base with a top surface and a circumference, and an annular side wall extending along the circumference of the base and having an inside surface and a rim, the method comprising:
displacing oxygen disposed near the top surface of the base of the cooking apparatus via one of at least one non-continuous segment or protrusion of the inside surface of the annular side wall above the top surface of the base or an inwardly sloping ring extending from the rim of the annular side wall; and
increasing an average ignition time of one or more of material or liquid disposed on the top surface of the base.

21. The method of claim 20, wherein displacing oxygen disposed near the top surface of the base of the cooking apparatus comprises recirculating one or more of moisture, gases or oils back into the top surface of the base via the at least one non-continuous segment or protrusion and reducing an overall temperature of one or more of the material or liquid disposed on the top surface of the base.

22. The method of claim 20, wherein displacing oxygen disposed near the top surface of the base of the cooking apparatus comprises increasing an inner curvature of the annular side wall via the inwardly sloping ring.
